(19) United States
(12) Patent Application Publication
(10) Pub. No.: US 2026/0272187 A1
(43) Pub. Date: Sep. 17, 2026

(54) INFLATABLE PATIENT TRANSFER MATTRESS

(71) Applicant: Yogen JASANI, Prescot Merseyside (GB)

(72) Inventor: Yogen JASANI, Prescot Merseyside (GB)

(21) Appl. No.: 19/137,542

(22) PCT Filed: Dec. 19, 2023
(86) PCT No.: PCT/GB2023/053316

§ 371 Date: Jun. 10, 2025

(30) Foreign Application Priority Data
Dec. 19, 2022 (GB) 2219212.4
Aug. 8, 2023 (GB) 2312150.2

(51) Int. Cl. A47C 27/08; A47C 27/00; A47C 27/10; A61G 7/10

(52) U.S. Cl. CPC A47C 27/081; A47C 27/007; A47C 27/10; A61G 7/1025

(57) ABSTRACT

An inflatable patient transfer mattress having: a lower portion with a lower air-permeable region configured to allow for the transfer of air from within the mattress to outside the mattress therethrough; an upper portion with an upper air-permeable region configured to allow for the transfer of air from within the mattress to outside the mattress therethrough; and an air inlet configured to allow for a supply of air to be provided into an inner region of the mattress, between the lower portion and the upper portion, therethrough.

### FIELD OF THE INVENTION

The present invention relates to the field of inflatable patient transfer mattresses.

### BACKGROUND TO THE INVENTION

Patient transfer mattresses are used extensively in hospitals and other care institutions. They are used to transfer patients across and between two adjoining surfaces such as hospital beds or stretchers.

Inflatable patient transfer mattresses have an inlet to receive air from an external air supply and an outlet to expel air. Typically, this outlet is in the form of perforations in a lower surface of the mattress. The force of the expulsion of the air through the perforations located in the lower surface of the mattress partially lifts and raises the mattress off the resting surface (for example a bed), or at least reduces friction between the mattress and the resting surface. The inflatable mattress is more easily movable due to a cushion of air created by the expulsion air through the perforations in the lower surface of the mattress. Typically, a bed sheet is laid over the patient transfer mattress to provide a suitable surface on which the patient can lie, rather than the upper surface of prior art patient transfer mattresses, typically formed from synthetic man-made fibres, such as waterproof fabrics and materials, including nylons, non-woven fabrics, etc.

It is in this context that the present invention has been devised.

### SUMMARY OF THE INVENTION

According to an aspect of the invention, there is provided an inflatable patient transfer mattress comprising: a lower portion comprising a lower air-permeable region configured to allow for the transfer of air from within the mattress to outside the mattress therethrough; an upper portion comprising an upper air-permeable region configured to allow for the transfer of air from within the mattress to outside the mattress therethrough; and an air inlet configured to allow for a supply of air to be provided into an inner region of the mattress, between the lower portion and the upper portion, therethrough.

Typically, inflatable patient transfer mattresses of the prior art comprise perforations on the lower portion of the mattress to allow for air to escape from the mattress. The upper portions of these prior art mattresses do not have any way in which air can escape therethrough. Accordingly, when a patient lies on these mattresses, heat build-up can occur, especially without a further separating portion being provided, such as a bed sheet. By incorporating a region which is air-permeable on the upper portion, air is allowed to transfer through the mattress and escape also through the upper portion. Accordingly, the inflatable patient transfer mattress is able to provide a cooling effect to the upper portion of the mattress which can aid in the temperature control of a patient. Significantly, even with air permeable regions at both the lower portion and the upper portion, the patient transfer mattress remains inflatable. In other words, the patient transfer mattress can still be inflated despite the air which permeates through both the upper and lower air-permeable regions of the upper and lower portions respectively. To achieve this, it will be understood that a limitation must be provided on the rate of air flow out of the mattress via the combination of the upper and lower air-permeable regions, which is no greater than the air which can be supplied to the mattress via the air inlet.

According to a further aspect of the invention, there is provided a first part of an inflatable patient transfer mattress comprising: a lower portion comprising a lower air-permeable region configured to allow for the transfer of air from within the first part to outside the first part therethrough; and an upper portion comprising an upper air-permeable region configured to allow for the transfer of air from within the first part to outside the first part therethrough; and an air inlet configured to allow for a supply of air to be provided into an inner region of the first part, between the lower portion and the upper portion, therethrough, wherein the first part of the inflatable patient transfer mattress is configured to form the inflatable patient transfer mattress when a breathable cover is secured to the upper portion and disposed over the upper air-permeable region, and wherein the upper air-permeable region is configured such that, in the absence of the breathable cover disposed over the upper air-permeable region and when an air supply is provided into the inner region of the first part, the first part will deflate with a patient lying thereon. The first part of the inflatable patient mattress is therefore configured such that it is unable to inflate in the absence of the breathable cover disposed thereon. Accordingly, the first part of the inflatable patient transfer mattress and the breathable cover are both required to provide an inflatable patient transfer mattress.

The first part of the inflatable patient transfer mattress forms the inflatable patient transfer mattress when a breathable cover is secured to the upper portion and disposed over the upper air-permeable region; however, in the absence of such a breathable cover, even when an air supply is provided into the inner region of the first part, the first part will typically deflate when a patient lies thereon. This is because the upper air-permeable region provided alone allows too much air to permeate therethrough for the patient transfer mattress to remain inflated, without the additional provision of the breathable cover thereon. The first part of the inflatable patient transfer mattress displays the temperature-control benefits described in relation to the inflatable patient transfer mattress provided by the upper air-permeable region. The first part also displays dual functionality. When combined with a breathable cover, it can form an inflatable patient transfer mattress. Alternatively, when used on its own and not with a breathable cover secured thereto, it can act as a cooling/warming mattress which allows for the transfer of air therethrough, but which does not necessarily inflate. The mattress can thus be used as an additional layer to a hospital bed or other mattress which provides cooling or warming air to regulate the temperature of a patient.

Moreover, the first part of an inflatable mattress is beneficial as it is a durable alternative to a single-use inflatable patient transfer mattress that can be combined with other parts (e.g. single-use parts) to form a complete inflatable patient transfer mattress. Accordingly, the first part of an inflatable patient transfer mattress can be re-used and could be cost-effective in the long-term by reducing or even completely eliminating the need to buy single-use mattresses for use with individual patients.

In some examples, it may even be that the present invention extends to an environmental control mattress comprising a lower portion and an upper portion, the upper portion comprising an upper air-permeable region configured to allow for the transfer of air from within the environmental control mattress to outside the environmental control mattress therethrough; and an air inlet configured to allow for a supply of air to be provided into an inner region of the environmental control mattress, between the lower portion and the upper portion, therethrough. Thus, air flow through an upper air-permeable region of the environmental control mattress may be used to provide temperature and/or humidity environmental control for a patient lying thereon, in a convenient manner. Features described hereinafter in relation to the inflatable patient transfer mattress or the first part thereof may be equally applicable to the environmental control mattress unless inherently incompatible.

The air-permeable region on either or both of the upper or the lower portion of the inflatable patient transfer mattress (or first part thereof) may be arranged so that the air-permeable region is disposed at different parts and across different areas of the upper and/or lower portions. For example, the air-permeable region on the upper portion may be disposed in a centrally located strip which approximately defines the shape and size of a typical patient. The upper air permeable region may be disposed across a width of more than 30 centimetres, such as more than 50 centimetres of the upper portion. The upper air permeable region may be disposed across a width of less than 1.5 metres, such as less than 1 metre of the upper portion. The upper air permeable region may be disposed across a length of more than 1 metre, such as more than 1.5 metres of the upper portion. The upper air permeable region may be disposed across a length of less than 2.5 metres, such as less than 2 metres of the upper portion. The lower air permeable region may be disposed across substantially the whole width and length of the lower portion.

It will be understood that air which is supplied into the inflatable patient transfer mattress (or first part thereof) through an external air supply can escape the mattress through the lower air-permeable region to form a cushion of air which aids in lateral movement of the mattress across a surface when a patient is lying thereon or through the upper air-permeable region to aid in temperature control of the patient on the mattress.

The upper and lower air-permeable regions may be configured as a sheet defining openings therein. In some examples, the openings may be considered perforations. The air permeable regions may comprise a porous membrane and/or a film.

In some embodiments the inner region of the mattress is defined by the volume enclosed by the upper portion and lower portion which are connected at their peripheral edges by one or more, for example, two, three or four side walls. In other embodiments, the inner region is defined by the volume enclosed by the upper portion and lower portion which are directly connected to one another at their peripheral edges (e.g. without separate side walls). The connections between panels forming the mattress may, for example, be made by high frequency welding, sewing or other connecting means. It will be understood that in some examples, some portions of the peripheral edges of the upper portion and lower portion are directly connected to one another, but other portions of the peripheral edges of the upper and lower portions are connected to each other via one or more side wall portions.

The inflatable patient transfer mattress is configured such that air is able to travel throughout the entire inner region. In this way, the inflatable patient transfer mattress has one main chamber through which air can flow through. All open regions in the inner region are in fluid communication with all other open regions in the inner region. The term open region is understood to mean a region of the inner region which is substantially free of obstruction to airflow where example of obstruction may, for example, include inflatable patient transfer mattress connecting elements such as baffles.

An air supply provided to the mattress may be able to provide enough air into the mattress so as to keep it inflated when in use (i.e. when a patient lies thereon). In the case of the first part of an inflatable patient transfer mattress a breathable cover is secured to the upper portion and disposed over the upper air-permeable region to maintain inflation in use. The power of the air supply can vary. The rate of air flow and the volume of the air flow supplied by the air supply may also be able to provide enough air at a rate which maintains the inflation of the mattress when in use. It will be understood that the air supply generator for providing the air supply may be configured to provide air having a pressure at least sufficient to ensure that the rate of air flow into the inflatable patient transfer mattress is sufficient for the mattress to remain inflated when a patient is lying thereon.

For example, the air supply could have an air flow ranging from 2,300 litres per minute at maximum power to 1,100 litres per minute at minimum power. However, this range is not intended to be limiting and the air flow may be greater than or less than this range of values. For example, the air supply could have a maximum air flow of 5,000 litres per minute. It will be understood that the air flow typically refers to the volumetric flow rate of air from the air supply into the inflatable patient transfer mattress, when the inflatable patient transfer mattress is loaded with an average-sized patient lying thereon.

It may be that the patient transfer mattress and the air supply together are configured to provide cooling or warming air to a patient lying thereon to regulate their temperature. For example, the patient transfer mattress and/or the air supply may comprise a heater or a cooler for heating or cooling the air to be output through the upper air-permeable region of the inflatable patient transfer mattress.

It will be understood that the term ‘inflatable’ means that the patient transfer mattress is able to retain a sufficient quantity of air within the structure such that an average-sized patient lying thereon will be lifted off the lower portion by the air pressure caused by the introduction of the air within the structure. In other words, the inflatable patient transfer mattress is deflated when no air is present within the mattress body and can then change to an inflated state when air is introduced into the mattress body at a rate sufficient to cause the patient to be raised off the lower portion of the inflatable patient transfer mattress. It will also be understood that the term ‘patient transfer mattress’ means a device which facilitates lateral movement of a patient lying thereon, relative to a surface on which the device is supported (e.g. the underlying bed). The lateral movement is facilitated at least partially using a reduction of friction between the mattress and the surface on which the mattress is supported by way of air flow between the mattress and the surface. The ‘lower portion’ of the mattress is the part of the mattress which is not in contact with the patient when in use and instead is in contact with the surface on which the mattress is supported when in use such as a hospital bed or a stretcher. Conversely, the upper portion of the mattress is the portion which is in contact with the patient in use—i.e. the top part of the mattress on which the patient lies (directly or indirectly).

It will therefore be understood that inflatable patient transfer mattress means a device which is able to retain a sufficient quantity of air in use, when a patient lies thereon and when the patient is moved laterally on the inflatable mattress which travels across a surface. The inflatable patient transfer mattress is not completely rigid unlike, for example, a patient support structure such as a board. Moreover, unlike patient support structures such as boards, the inflatable patient transfer mattress, as well as being flexible, has a chamber.

The inflatable patient transfer mattress (or first part thereof) may be configured such that at least a part of the upper portion and at least a part of the lower portion of the inflatable patient transfer mattress are flexible. In some embodiments, at least 50% of the part of the upper portion and at least 50% of the part of the lower portion are flexible.

By a first part of an inflatable patient transfer mattress, it is understood to mean that the first part is a component part of the inflatable patient transfer mattress, and therefore requires the use of an additional component part to function as a complete inflatable patient transfer mattress otherwise the mattress will not inflate. In this case the additional component part may be a breathable cover. It will be understood that an air permeability rate of the breathable cover in a region arranged to overlay the upper air-permeable region of the first part of the inflatable patient transfer mattress is lower than the air permeability rate of the upper air-permeable region of the first part of the inflatable patient transfer mattress without the breathable cover disposed thereover.

The upper air-permeable region of the inflatable patient transfer mattress may further comprise a breathable portion. Thus, air and water vapour—i.e. water in a gaseous form—are able to pass through the breathable portion of the upper air-permeable region, which can help to reduce or even completely prevent discomfort of the patient by allowing water vapour from sweat to pass therethrough. As sweat vapour can pass through the breathable portion and air can pass out of the mattress through the entire upper air-permeable region and breathable portion comprised in the upper air-permeable region, the patient can experience effective environmental (e.g. temperature) control from the air flow and removal of sweat. It will be understood that the term breathable typically means that air and water vapour—i.e. water in a gaseous form, but not liquid water, can pass through a material. The breathable portion therefore allows for the transmission of air and vapour, but is itself substantially waterproof. The breathable portion can be integral to the upper air-permeable region.

For example, the breathable portion could be a breathable film such as a polytetrafluoroethylene (PTFE) stretchable microporous membrane or a hydrophilic laminate comprised within the upper air-permeable region.

Alternatively, the inflatable patient transfer mattress may further comprise a breathable portion secured to the upper portion and disposed over the upper air-permeable region such that, when inflated and supplied with an air flow from the air supply, with a patient lying on the mattress, a rate of air flow from within the mattress, through the upper air-permeable region and out through the breathable portion is sufficiently low that the mattress remains inflated. The breathable portion can therefore be separate to the component part of the inflatable patient transfer mattress including the upper portion and the lower portion, and secured thereto using securing means. The securing means may be Velcro®, tape, adhesive, or any other way in which a connection between the upper portion of the mattress and the breathable portion can be formed that is sufficient to maintain inflation of the mattress when in use. As for the breathable portion integral to the upper air-permeable region, the breathable portion may be part of, for example, a sheet such as a cotton sheet, or it may form the entirety of a layer which is disposed on top of the mattress such as a PTFE stretchable microporous membrane or a hydrophilic laminate layer. A patient of average size lying on the inflatable patient transfer mattress may be between 50 kg to 120 kg.

The breathable portion of the inflatable patient transfer mattress is configured such that, when secured to the upper portion of the mattress, and when the mattress is inflated and supplied with an air flow from the air supply, with a patient lying on the mattress, a rate of air flow from within the mattress, through the upper air-permeable region and out through the breathable portion is sufficiently low that the mattress remains inflated. Accordingly, the breathable portion allows for air retention of the mattress at the same time as providing air permeability and the passage of vapour therethrough with associated patient comfort advantages. The inflatable patient mattress is therefore configured such that it is unable to inflate in the absence of the breathable cover disposed thereon.

This can be achieved in different ways. For example, the breathable portion may be located in an area which is directly underneath a patient when a patient lies on the mattress. For example, the breathable portion could be integral to the upper air-permeable region and span a central area of the upper air-permeable region. For example, the breathable portion may span a width of from 0.30 to 0.60 m and a length of 1.5-1.9 m of the upper air-permeable region. Alternatively, the breathable portion, when secured to the upper portion of the mattress as a sheet could span a width of from 0.30 to 0.60 m and a length of 1.5-1.9 m of the upper air-permeable region. By locating the breathable portion in an area which is directly underneath the patient when a patient lies on the mattress, the breathability and temperature control effects of the mattress are enhanced. Typically, in use, the patient covers the breathable portion allowing for improved moisture wicking of sweat from the body of the patient. The mattress may also benefit from air retention as at least some of the breathable portion is typically covered by the patient and the rest of the air-permeable region can allow for smaller amounts of air loss therethrough at the same time as allowing the mattress to maintain an inflated state. Accordingly, the breathable portion may be located, either when secured to the upper portion and disposed over the upper air-permeable region or when integral to the upper air-permeable region, in a central area of the upper portion spanning a width of from 0.30 to 0.60 m and a length of 0.9-1.9 m of the upper air-permeable region. Alternatively, the breathable portion could be arranged in a plurality of strips which span a central area of the upper air-permeable region, either when the breathable portion is secured to the upper portion and disposed over the upper air-permeable region or when integral to the upper air-permeable region. Thus, breathability can be spread across the mattress. Shapes or defined areas other than strips could also be used. For example, circular regions could also define the area(s) to which the breathable portion conforms. The breathable portion could therefore be spread across many different regions of the mattress and not just directly underneath where a patient will lie on the mattress when in use.

The breathable portion may be a coating or a film. In some embodiments, the coating or film may comprise apertures that are either inherent to the material used and/or that have been mechanically or chemically formed in the material. The coating or film be stretchable. In this way, the material may provide a flexible effect to enhance comfort to a user lying thereupon. This is because, as the user moves, the stretchable nature of the film means that it can move with the movement of the user and therefore it reduces friction between the upper portion and the user. In some embodiments, the elasticity of the coating/film may be provided by a uniaxial stretch such as a two-way stretch (e.g. able to stretch horizontally or vertically across the coating/film in opposite directions) or a biaxial stretch such as a four-way stretch (e.g. able to stretch horizontally and vertically across the coating/film in opposite directions). In some embodiments, the elasticity of the coating/film may be provided as a multidirectional stretch. In this way, the material may be able to stretch in any direction; accordingly, enhanced comfort can be provided to the patient when they move on the mattress. It may be that the material may be configured to be stretchable in a lengthwise direction of the patient transfer mattress. Thus, when a patient moves lengthways (in a direction parallel to the direction between the head and the feet of the patient) relative to the mattress, whilst on the mattress, the film can stretch in that direction to reduce stiction between the film and the body of the person.

The upper air-permeable region and/or the lower air-permeable region of inflatable patient transfer mattress (or first part thereof) may comprise a plurality of openings. This allows for the passage of air through the upper air-permeable region in a controlled manner. The size, number, location and distribution density of the openings can all be determined according to the intended use of the mattress and the expected type of patient who will lie thereon. For example, and as alluded to above, if a larger patient is to lie on the inflatable patient transfer mattress or the first part of an inflatable patient transfer mattress, it may be that the size of the openings is larger, the number of openings may be greater and/or the distribution of the openings across the upper air-permeable region and/or lower air-permeable region may be more spread out, as compared to an inflatable patient transfer mattress for use with a smaller patient. The internal pressure of the mattress can be increased/decreased respectively by increasing/decreasing the number and/or size of the openings in the upper air-permeable region and/or lower air-permeable region.

It may be that a total surface area of the upper air-permeable region is greater than 0.25 m². The total surface area of the upper air-permeable region may be greater than 0.5 m². The total surface area of the lower air-permeable region may be less than 2 m². The total surface area may be less than 1.5 m².

Each of the openings in the plurality of openings may be sized to prevent the passage of liquid (e.g. water) therethrough. Thus, water and other liquids are prevented from entering the mattress inner region. This is particularly useful in a medical setting such as for use in a hospital or care home when mattresses are used by patients and need to be cleaned regularly. By having the openings of a size which prevents the passage of liquid therethrough, any liquids which come into contact with the upper air-permeable region can be wiped off and the upper air-permeable region can be effectively cleaned without any liquid ingress into mattress. Liquid ingress into the mattress can also interfere with the effective operation of the air permeability of the mattress.

The term ‘size’ used to describe the opening is understood to mean the overall lateral extent of the opening in the plane of the opening. Accordingly, when the openings are sized to prevent the passage of liquid therethrough, liquid is prevented from passing through the material regardless of the shape of the opening.

The surface area of each of the openings in the plurality of openings can be such that a liquid (e.g. water) is prevented from passing through the plurality of openings. For example, the surface area of the openings could range from greater than 0.00 mm² to 0.50 mm². For example, the surface area of each opening may be less than 0.50 mm², such as less than 0.30 mm². The surface area of each opening may be greater than 0.05 mm², such as greater than 0.10 mm², for example greater than 0.15 mm².

The diameter or extent of each of the openings in the plurality of openings may be from greater than 0.00 μm to 0.25 μm. For example, the diameter or extent of each opening may be less than 0.25 μm, such as less than 0.20 μm. The diameter or extent of each opening may be greater than 0.05 μm, such as greater than 0.10 μm.

The inflatable patient transfer mattress or the first part of an inflatable patient transfer mattress may further comprise a single region of the lower portion, typically containing most if not all of the lower-air permeable region. The single region may include no more than 30 percent of any non-air permeable region of the lower portion, and function to provide at least 70 percent of the air permeability of the lower air permeable region.

In some embodiments, at at least 70 percent of surface locations within the single region, a location of the lower portion being air permeable may be provided within less than five centimetres.

Typically, inflatable patient transfer mattresses have perforations in the lower portions thereof that are not evenly distributed and that largely follow an outline of a patient that lies thereon. In this typical configuration, large regions of the lower portion do not allow air to pass through. In particular, a large proportion of a central area of the lower portions do not have openings defined therein. Accordingly, it can be challenging to achieve sliding of typical inflatable patient transfer mattresses across a surface. The central region of the inflatable patient transfer mattress is where most of the weight of a patient lying thereon will be distributed on the upper portion lying directly above the lower portion. By arranging the lower portion of the mattress described as above, such that a single region of the lower portion includes no more than 30 percent of any non air permeable region of the lower portion and functions to provide at least 70 percent of the air permeability of the lower air permeable region, and at at least 70 percent of surface locations within the single region, a location of the lower portion being air permeable is provided within less than five centimetres, a greater uniformity of the air permeability of the lower portion is achieved. This vastly improves the expulsion of air from the lower portion of the mattress above which a patient will lie thereon. This is due to a greater cushion of air created by the expulsion air through the more evenly distributed air permeable region in the lower portion. The air permeable region being distributed such that it is largely located in line with, and underneath, the heaviest part of a patient that will lie on the inflatable patient transfer mattress.

In some embodiments, the single region of the lower portion may include no more than 20 percent, such as no more than 10 percent, for example none, of any non-air permeable region of the lower portion. In some embodiments, the single region of the lower portion may function to provide at least 80 percent, such as at least 90 percent, for example all, of the air permeability of the lower air permeable region. In some embodiments, at at least 80 percent of, such as at at least 90 percent of, for example at all, surface locations within the single region a location of the lower portion being air permeable is provided within less than five centimetres, such as less than four centimetres, for example less than three centimetres, or even less than two centimetres.

In some embodiments, the air permeability of the air permeable region is provided through a plurality of openings arranged in the single region. In some embodiments, the plurality of openings are arranged in groups comprising columns and rows of openings. There may be greater than or equal to 5, for example, 5, 6, 7, 8, 9 or 10 groups. The groups may comprise one or more (e.g. a plurality) of columns and rows. Each column of openings may be separated laterally by a distance, d1, from an adjacent column of openings within the same group. Each group may be separated by a distance, d2, from an adjacent group. Each row may be separated by a distance, d3, from an adjacent row. The distance d2 may be greater than the distance d1. The distance d2 may be greater than the distance d3. The groups nearest an outer perimeter of the lower portion may comprise fewer columns than groups nearest a centre of the lower portion. There may be a highest distribution of openings within a central part of the single region. The central part of the single region is understood to mean the part of the single region above which the majority of a patient's weight will be distributed on the upper portion of the inflatable patient transfer mattress.

In some embodiments, the single region of the lower portion may be arranged such that each internal angle of a shape defined by an outer perimeter of the single region is no more than 270 degrees, such as no more than 220 degrees, for example no more than 180 degrees. Accordingly, any non-air-permeable regions outside of the single region are confined to a small area bordering the single region and therefore, there are no non-air-permeable regions of significant area outside of the single region. A point on the outer perimeter of the single portion may be 5 cm or less from a corresponding point on an outer perimeter of the lower portion, the corresponding point being a point on the lower portion outer perimeter that is closest to the point on the outer perimeter of the single portion. In this way, the shape defined by the outer perimeter of the single region efficiently covers a large proportion of the lower portion for effective air expulsion which aids the smooth transfer of a patient on the mattress across a surface. The air permeability of the single region may be provided through a plurality of openings. The openings may be arranged in a grid. The openings may be arranged such that a distance between any individual opening and any individual closest neighbour opening in any direction (e.g. laterally, longitudinally or diagonally) will be the same. For example, a distance between any neighbouring openings may be from 4 mm to 18 mm. The size of the openings may vary. For example, the size of the openings may be between 0.1 to 1.8 mm in diameter or largest extent. The openings may be larger in in a central area of the single region and smaller in a peripheral region nearest the outer perimeter of the single region. For example, the openings in a central region of the single region may be from 20 to 50% larger than the openings closest to the outer perimeter of the single region. There may be a gradient of size of the openings increasing from the openings closest to the outer perimeter until reaching the openings in the central area of the single region (which lies below the area on top of which the heaviest part of the patient lies). In this way the largest air expulsion will be provided at the regions where a patient lying thereon will have most of their weight concentrated and the outer edges of the single region, not populated or only populated by a lighter part of the patient will not require as much lift through the air expulsion force.

The inflatable patient transfer mattress (or first part thereof) may further comprise at least one connecting element extending between the upper portion and the lower portion of the mattress through the inner region. Typically, inflatable mattresses balloon (i.e. bulge) in the absence of such connecting elements. It will be understood that a mattress which is overly bulging will be unsuitable for use in patient transfer as the contact area between the mattress and the surface over which it is to be moved will reduce, as well as because a patient may more easily roll off a bulging mattress. Provision of the connecting element(s) as described above prevents this ballooning owing to the connection that is made between the upper and lower portions of the mattress. Accordingly, structural reinforcement is provided to the mattress through the connecting element(s). There may be one or more connecting elements.

The at least one connecting element may comprise an air-permeable portion such that air from within the mattress can pass through the at least one connecting element in the inner region of the mattress. Accordingly, even if the at least one connecting element extends across an entire dimension of the inner region, air is still able to pass through the at least one connecting element to access the entire inner region. The air can therefore pass from one open region of the inner region to another open region of the inner region through the air-permeable portion on the at least one connecting element. The air-permeable portion of the at least one connecting element may be arranged as an aperture or plurality of apertures, a breathable film or membrane or any other configuration allowing for the passage of air. The air-permeable portion(s) may be arranged on at least one sidewall of said at least one connecting element. The air-permeable portion(s) also allow for an increased air circulation within the inner region when the at least one connecting element does not fully extend across an entire dimension of the inner region.

The at least one connecting element may be a plurality of connecting elements, defining a plurality of pods. The plurality of pods provide structural reinforcement to the mattress, preventing ballooning.

The plurality of pods may each extend over a minimum distance between the lower portion and the upper portion of the mattress. In this way, the pods extend vertically through the inner region of the air mattress and thus can provide an array of structural reinforcement.

The plurality of pods may be connected from the lower portion to the upper portion in a variety of different ways. In some embodiments, the pods are separate entities to the mattresses and are attached via external means.

In some embodiments, at least a part of the upper air-permeable region forms part of an upper surface of the pod at the upper portion of the mattress. Thus, air from within the inner region of the mattress can escape the mattress through the air-permeable material on the upper surface of the pods. The pods can therefore facilitate even distribution of air flow through the upper portion of the mattress by allowing for air flow through the upper surface of the pod. The part of the upper air-permeable region which forms part of the upper surface of the pod may be a part which makes up greater than 5% of the pod upper surface, for example, greater than 10% of the pod upper surface or greater than 20% of the pod upper surface.

The plurality of pods may comprise openings on a lower and/or upper surface of the pod. Accordingly, the pod may comprise openings on the upper portion and/or lower portion of the mattress. Therefore, the pod may allow for the air flow through either the upper, the lower or both the upper and lower portion out of the mattress.

In some embodiments, the plurality of pods are arranged in a geometric array. In this way, the pods are arranged in a pattern such as a square, a rectangle, a trapezoid.

In some embodiments, the plurality of pods are evenly distributed within the inner region of the mattress. In this way, the pods are spread throughout the mattress. The pods can be evenly distributed by being arranged in repeating rows or columns throughout the mattress.

In some embodiments, the plurality of pods comprise side walls which are walls on the substantially vertical (e.g. longest) edges of the pods. The side walls of the pods may comprise an air-permeable portion such as openings. The air-permeable portion (e.g. openings) on the side walls provide a route for air to flow from within the inner region of the mattress, into the pod and out through the upper surface of the pod, as well as allowing air flow through the entire inner region between the pods. The air can therefore pass from one open region of the inner region to another open region of the inner region through the air-permeable portion of the plurality of pods. The air-permeable portion(s) also allow for an increased air circulation within the inner region when the pods do not fully extend across an entire dimension of the inner region.

In some embodiments, at least one pod in the plurality of pods is divided into two portions by a perforated disc positioned part way along the pod. In this way, a division between the upper and lower portion of the pod is provided and the upper portion of the pod can act as a storage chamber with the air contained therein being released through the perforated disc. The stored air in the upper portion of the pod can therefore be released generally only when required, for example when the patient moves or shifts their weight around on the patient transfer mattress.

The pod will be understood to be a structural feature of the inflatable patient transfer mattress (or the first part thereof) which defines a sub-volume within the inner region.

The at least one connecting element in the inflatable patient transfer mattress (or first part thereof) may define at least a part of a plurality of baffles. At least a part of the plurality of baffles provides structural reinforcement via the extension of the at least a part of a plurality of baffles through the inner region of the mattress. The baffles (or part thereof) may extend across the width of the mattress. The baffles (or part thereof) may also extend across the length of the mattress. Accordingly, a series of parallel rows of baffles can be provided in the inner region of the mattress either across the width or length of the mattress. Alternatively, a grid-like formation of intersecting baffles extending across the length and width of the mattress can be formed.

The plurality of baffles may be connected to the upper and lower portions of the mattresses through sewing, heat sealing or high frequency welding techniques or through fastening means such as adhesive, clips or other fastening means. The baffles may be connected to the upper and lower portions of the mattress across the entire length of the baffle. Alternatively, the baffles may be connected to the upper and lower portions at a plurality of spaced points across the length of each baffle. Accordingly, there may be spacing between points along the baffle where the baffle is connected to the upper and/or lower portions of the mattress—i.e. connecting points. For example, a spacing between connecting points on both the upper and lower portion of a mattress where the baffle is connected to the mattress may be in the range of from 1 cm to 30 cm. For example, a spacing between connecting points where the baffle is connected to both the upper and lower portions may be approximately 5 cm. In any inflatable patient transfer mattress or first part thereof, spacing between connection points may be present between a pair of connecting points where the baffle is connected to both the upper and lower portions and another pair of connecting points where the baffle is connected to the mattress at both the upper and lower portions or where the baffle is connected to the upper portion at one connecting point and there is a space measured horizontally along only the length of the baffle between this connecting point and another connecting point where the baffle is connected to a lower portion of the mattress (i.e. not measuring the ‘hypotenuse’ distance between these connecting points).

The term baffle is understood to mean a planar object which directs the air flow in the region it is located by causing an obstruction. It could also be referred to as a tether. The baffles can be made out of any material that is able to form a solid planar object that is connectable to the upper and lower portions of the mattress. Accordingly, when a plurality of baffles is present in the inner region of the mattress extending across a width of the mattress, the air flow into the mattress is directed through channels formed by the baffles across the width. Alternatively, when the plurality of baffles is present in the inner region extending across the length of the mattress, the air flow into the mattress is directed through the channels formed by the baffles across the length of the mattress.

In some embodiments, each of the plurality of baffles extends laterally across at least 50% of a width of the mattress through the inner region. The baffles can therefore be configured across the width of the mattress in a variety of different ways by varying the degree to which the baffles extend across the width. The degree to which the baffles extend provides versatility in terms of the air circulation that is provided in the mattress. The larger the degree of extension across the width, the lower the air distribution in the mattress. Preferably, the lateral extension of the baffles across the width of the mattress is closer to 50%, for example, between 50-70%. In this way, there is space at the end of each baffle for the air to circulate in which improves the shape of the mattress when inflated. The baffles may extend fully across the width of the mattress. When the baffles extend across the full width of the mattress, at least one opening in each of the baffles is required so that the air provided from the air supply can be distributed throughout the mattress. The at least one opening in each of the baffles can be of any size sufficient to allow for the passage of air through the baffle and into connecting regions of the mattress. The baffles may extend across from 50-100 % of the width of the mattress through the inner region. For example, the baffles may extend from 50-60%, 50-70%, 50-80%, 50-90% or 50-100% of the width of the mattress, including any value in between. For example, the baffles may extend across 75%, 80%, 85% or 99% of the width of the mattress through the inner region.

The baffles may comprise an air-permeable portion such as an opening or openings that allow for the passage of air therethrough. The air-permeable portion(s) in the baffles (e.g. openings) allow for the passage of air between a baffle and the inner region. Accordingly, even if a baffle were to extend fully across a length or width of the mattress, the provision of the air-permeable portion(s) allows air to flow throughout the entire inner region. The air can therefore pass from one open region of the inner region to another open region of the inner region through the air-permeable portion on the baffle(s). The air-permeable portion(s) also allow for an increased air circulation within the inner region when the baffles do not fully extend across an entire dimension of the inner region.

In some embodiments, the upper portion of the inflatable patient transfer mattress (or the first part thereof) may comprise an absorbent portion or may be provided with an absorbent layer disposed thereon. The absorbent portion or absorbent layer provides additional benefit to the mattress as it can absorb sweat and/or other bodily fluids and provide a comfortable environment for the patient to lie upon. The absorbent portion can comprise any material which is capable of absorbing liquids including sweat. For example, the absorbent portion may comprise at least one of cotton, viscose or a combination/blend of the two materials.

An absorbent material may be combined with the air-permeable region material to form the absorbent portion. Alternatively, a breathable portion of the mattress may comprise an absorbent material. In other words, the portion of the upper portion of the inflatable patient transfer mattress which provides the air-permeable region may also function as the absorbent portion. The portion of the upper portion of the mattress that the absorbent material is present on can be any size or extended across any surface area of the upper portion. When an absorbent material is present in the upper air-permeable region material, this absorbent material may extend across the whole of the upper air-permeable region. For example, the absorbent material could be included in a mix of the upper air-permeable region material which results in a homogenous distribution of the absorbent material across the upper air-permeable region. The same applies if the absorbent material is comprised in the material of a breathable portion of the upper portion.

An absorbent layer may be provided to the mattress through different ways. For example, the absorbent layer may be secured to the upper portion by various mechanical methods of attachment such as Velcro®, adhesive, fastenings or otherwise. Alternatively, the absorbent layer may be deposited on the upper portion through lamination or coating means depending on the form and materials used in the absorbent layer.

In some embodiments, the inflatable patient transfer mattress (or first part thereof) comprises an upper portion comprising a breathable portion and an absorbent portion. The absorbent portion may be, for example, a film or a coating which is attached to the breathable portion. Methods of attachment of the absorbent portion to the breathable portion may include lamination, adhesive, electrically induced attachment or other suitable means. In some embodiments, the absorbent portion and the breathable portion may be distinct regions of the upper portion of the inflatable patient transfer mattress (or first part thereof). In some embodiments, the absorbent portion provides the breathable portion.

When air is supplied into the inner region of the inflatable patient transfer mattress or first part thereof, e.g. by an air pump, and a patient is lying thereon, the absorbent portion or layer may absorb liquids, such as sweat emanating from the patient, and the air from within the inner region of the mattress may travel out of the inner region through the upper air-permeable region so as to facilitate evaporation of the liquid absorbed in the absorbent portion or layer. In this way, the absorbent portion can fulfil its absorbing role and the air travelling out of the upper air-permeable region can act to gradually remove liquid from the absorbent portion or layer such that it can absorb more liquid, such as sweat emanating from a patient, for longer.

It is to be understood that the higher the rate of air supplied into the inner region, the higher the rate of evaporation of liquids from the absorbent portion or layer and the increase in the time in which the absorbent portion or layer takes to become saturated.

Once saturated, the absorbent portion or layer may be cleaned or disposed of and replaced. In other examples, it will be understood that supplying air for a sufficient period of time may dry the absorbent portion again, allowing it to be re-used one or more further times.

According to a further aspect of the invention, there is provided a breathable cover for overlaying an upper air-permeable region of an upper portion of the first part of an inflatable patient transfer mattress to form an inflatable patient transfer mattress, wherein the breathable cover comprises securing means for securing the breathable cover to the first part of the inflatable patient transfer mattress, the securing means, when securing the breathable cover to the first part, to cause the breathable cover to restrict air flow from within the mattress to outside the mattress through the upper air-permeable region. The breathable cover acts as a modular component of an inflatable patient transfer mattress and provides sufficient air-retention properties to the inflatable patient transfer mattress when used in conjunction with the first part of an inflatable patient transfer mattress that the combination of the first part and the breathable cover are able to function as an inflatable patient transfer mattress as described hereinbefore. This is achieved as the breathable cover overlays the upper air-permeable region and therefore it reduces the amount of air that escapes the mattress through the upper air-permeable region. In addition to providing air retention properties, the breathable cover is able to provide temperature regulation when a patient lies thereon. This is achieved as the breathable cover is still able to allow some amount of air to permeate through it from within the inner region of the mattress through the upper air-permeable region and out of the breathable cover, in addition to allowing water vapour (e.g. in the form of sweat) through it when a patient lies thereon. The breathable cover still, however, provides a waterproof barrier to any liquids entering from the outside of the mattress.

The breathable cover may be formed from any material that allows for the passage of air and water vapour therethrough but that blocks the passage of water therethrough. For example, the breathable cover may be formed from a polytetrafluoroethylene (PTFE) stretchable microporous membrane or a hydrophilic laminate.

The breathable cover may comprise a film. The film may be an elastic film. The elasticity allows the material to stretch in multiple directions and can reduce the risk of pressure related injuries.

The breathable cover may comprise an absorbent material or be provided with an absorbent material deposited thereon. The absorbent material may comprise any material which is capable of absorbing liquids including sweat and other bodily fluids. For example, the breathable portion may comprise an absorbent material such as at least one of cotton, viscose or a combination of the two.

The breathable portion of the breathable cover may be a coating or a film. In some embodiments, the coating or film may comprise apertures that are either inherent to the material used and/or that have been mechanically or chemically formed in the material. The coating or film be stretchable. In this way, the material may provide a flexible effect to enhance comfort to a user lying thereupon. This is because, as the user moves, the stretchable nature of the film means that it can move with the movement of the user and therefore it reduces friction between the upper portion and the user. In some embodiments, the elasticity of the coating/film may be provided by a uniaxial stretch such as a two-way stretch (e.g. able to stretch horizontally or vertically across the coating/film in opposite directions) or a biaxial stretch such as a four-way stretch (e.g. able to stretch horizontally and vertically across the coating/film in opposite directions). In some embodiments, the elasticity of the coating/film may be provided as a multidirectional stretch. In this way, the material may be able to stretch in any direction and accordingly enhanced comfort can be provided to the patient when they move on the mattress. It may be that the material may be configured to be stretchable in a lengthwise direction of the patient transfer mattress. Thus, when a patient moves lengthways (in a direction parallel to the direction between the head and the feet of the patient) relative to the mattress, whilst on the mattress, the film can stretch in that direction to reduce stiction between the film and the body of the person.

The inflatable patient transfer mattress (with or without the breathable cover attached thereto) may be air-permeable such that air in the inner region can travel through the inner region, including between all open regions to all other open regions through any connecting elements present, and through the upper and the lower portions.

An outer perimeter of the securing means of the breathable cover may enclose an area of the breathable cover of greater than 0.1 m². The area may be greater than 0.2 m². The area may be greater than 0.5 m². An outer perimeter of the securing means of the breathable cover may enclose an area of the breathable cover of less than 5 m². The area may be less than 3 m². The area may be less than 2 m². This enables the breathable cover to overlay the inflatable patient transfer mattress sufficiently to provide air-retention to the inflatable patient transfer mattress formed when the breathable cover is secured onto the first part of the inflatable patient transfer mattress. The outer perimeter of the securing means may be any shape which conforms with the area of the upper air-permeable region of a first part of an inflatable patient transfer mattress so that efficient overlay is achieved and air-retention is improved.

The inflatable patient transfer mattress may further comprise at least one sensor. The at least one sensor may be comprised in the upper portion of the inflatable patient transfer mattress. The first part of the inflatable patient transfer mattress may comprise at least one sensor. The at least one sensor may be comprised in the upper portion of the first part of an inflatable patient transfer mattress. At least one sensor may be comprised in the upper air-permeable region and/or the lower air permeable region of the inflatable patient transfer mattress or the first part thereof. The breathable cover may comprise at least one sensor. The at least one sensor may be comprised in substantially any region of the breathable cover. At least one sensor comprised within the inflatable patient transfer mattress, first part thereof, or breathable cover may be integrally formed within each respective component. At least one sensor may be comprised within at least one layer of a coating or a film of the upper portion of the inflatable patient transfer mattress, a first part thereof, or an upper portion of a breathable cover. The sensor may be configured to detect one or more parameters associated with a patient lying on the inflatable patient transfer mattress. At least one of the one or more parameters may be indicative of a mass of the patient. At least one (e.g. a different one) of the one or more parameters may be indicative of a temperature of the patient. By providing the sensor to the mattress (or mattress parts), one or more parameters relating to a patient's well-being can be obtained which can also influence how a patient is subsequently treated. It may be that a plurality of sensors are provided, optionally distributed in different portions of the mattress (or mattress parts). The type of sensor can include, but is not limited to, a temperature sensor, a pressure sensor and a humidity sensor. The sensor(s) can be located across any region on the inflatable patient transfer mattress (such as any region on the upper portion of the inflatable patient transfer mattress) or first part and the breathable cover. For example, the sensor can be positioned to directly contact a patient when they lie on the mattress. If a sensor is located on the upper portion of an inflatable patient transfer mattress or the breathable cover when secured to a first part of an inflatable patient transfer mattress, temperature, humidity and pressure data (for example) can be obtained to give an accurate reading of the environment surrounding the patient. For example, if the temperature data is obtained, this can inform a clinician to increase or reduce the temperature of the environment surrounding the patient. Moreover, if a pressure sensor indicates that a pressure on one part of the patient's body is too high, the patient can be moved to reduce this pressure. The first part of a breathable mattress may comprise a sensor and a breathable cover secured thereto may also comprise a sensor. In this way an inflatable patient transfer mattress could be formed with multiple layers of sensors which provide local information relating to numerous parameters such as temperature, humidity and pressure. Accordingly, more accurate data could be provided to a healthcare professional as to the physical condition of a patient and how to change this condition through either external stimuli or changing the air supply into the mattress to allow for more cooling or more heated air to be provided to the mattresses.

In some examples, the at least one sensor may be provided in or around the pods, or on the baffles.

It will be understood that the inflatable patient transfer mattress may comprise a communications component configured to transmit (e.g. wirelessly) an output from the at least one sensor (or output signals determined therefrom), out of the inflatable patient transfer mattress, to a further device.

In some embodiments, the inflatable patient transfer mattress may further comprise one or more (e.g. a plurality of) straps for securing a patient to the inflatable patient transfer mattress. Thus, the patient can be retained safely on the inflatable patient transfer mattress during operation. At least one of, such as each of the one or more straps may be reconfigurable into a stowage configuration in which an end of the strap will not be on the floor around the inflatable patient transfer mattress. At least one of, such as each of the one or more straps may be removably attachable to a further portion of the inflatable patient transfer mattress. It will be understood that the straps may typically be fairly long, and might therefore obstruct operation of the inflatable patient transfer mattress when not being used to strap in a patient. Therefore, by making the straps able to be reconfigurable into a stowage configuration (e.g. by being removably attachable), an end of the straps can be prevented from contacting the ground when not required. The straps can be reconfigured out of the stowage configuration into a use configuration (e.g. re-attached) when required for strapping a patient to the inflatable patient transfer mattress.

In the use configuration, at least one strap may be attached to a further portion of the inflatable patient transfer mattress at a connection point on the inflatable patient transfer mattress. In the stowage configuration, the at least one strap may be removed from the inflatable patient transfer mattress by disconnecting from the connection point. In some embodiments, in the stowage configuration, the at least one strap may be at least partially received by a receiving component attached to the inflatable patient transfer mattress. For example, the inflatable patient transfer mattress may further comprise at least one pocket which can at least partially receive at least one strap in the stowage configuration. In some embodiments, the inflatable patient transfer mattress comprises at least one receiving protrusion which is configured to hold at least a part of one strap off the ground in the stowage configuration. For example, the at least one protrusion could be used to wrap the strap around it. In some embodiments, the inflatable patient transfer mattress may comprise attachment components such as hook and loop type fastenings e.g. Velcro® arranged such that at least a part of the strap may be in a stowage configuration when at least a part of the strap is attached to the inflatable patient transfer mattress via the hook and loop type fastening. For example, a side wall of the inflatable patient transfer mattress may comprise a strip of hook-type material and at least a part of the strap may comprise a loop-type material such that, in the stowage configuration, at least part of the strap can be attached to the strip of hook-type material and make a hook-loop connection.

The straps may each be two-part straps. In other words, the straps are formed from a first strap portion arranged to connect with a second strap portion to provide the strap described hereinbefore. Each portion of the two-part strap may terminate in a connection member part, together forming a connection member to secure the first portion to the second portion when the first strap portion is connected to the second strap portion via the connection member. The connection member may be a buckle connection. The strap may be connected to a main body of the inflatable patient transfer mattress, such as the side wall of the inflatable patient transfer mattress via a detachable and re-attachable connection. The detachable and re-attachable connection may be a zip connection, a hook and loop connection, or any other suitable connection.

In some embodiments, the inflatable patient transfer mattress may further comprise one or more (e.g. a plurality of) handles for moving the inflatable patient transfer mattress, for example, for moving the mattress across a surface or for lifting the mattress from one position to another. At least one of, such as each of the one or more handles may be reconfigurable into a stowage configuration in which at least a part of the handle is removed from a use position such that free access to a patient lying on the inflatable patient transfer mattress main body by e.g. a patient caregiver is permitted. At least one of, such as each of the one or more handles may be removably attachable to a further portion of the inflatable patient transfer mattress. Therefore, by making the handles able to be reconfigurable into a stowage configuration (e.g. by being removably attachable), the ease of access to the inflatable patient transfer mattress is improved. The handles can be reconfigured out of the stowage configuration into a use configuration (e.g. re-attached) when required for moving, e.g. lifting, the inflatable patient transfer mattress. In this way, when at least one handle is configured in the stowable configuration, a patient caregiver can approach the inflatable patient transfer mattress and attend to the patient without the at least one handle impeding their access. In some embodiments, in the use configuration, the handle may be attached at a connection point on a further portion of the inflatable patient transfer mattress. In the stowage configuration, the handle may be removed from the inflatable patient transfer mattress by disconnecting from the connection point. In some embodiments, in the stowage configuration, at least one handle may be at least partially received by a receiving component attached to the inflatable patient transfer mattress. For example, the inflatable patient transfer mattress may comprise at least one pocket which can at least partially receive the handles in the stowage configuration. In some embodiments, the inflatable patient transfer mattress comprises at least one receiving protrusion which is configured to hold at least a part of at least one handle off the ground and out of an obstructing position to a patient caregiver in the stowage configuration. For example, the at least one protrusion could be used to wrap the handle around it. In some embodiments, the inflatable patient transfer mattress may comprise attachment components such as hook and loop type fastenings e.g. Velcro® such that at least a part of the handle may be in a stowage configuration when attached to the inflatable mattress via the hook and loop type fastening.

In some embodiments, the handles comprise a rigid material. The handles may, when in a use configuration, be in a fixed position. For example, the handles may extend from a sidewall of the inflatable patient transfer mattress when in a use configuration. In some embodiments, at least one handle comprises a compressible material such that the at least one handle can adopt a compressed state where the at least one handle extends to a limited point away from the inflatable patient transfer mattress in a stowage configuration and a relaxed state such that, in the use configuration, the at least one handle extends to a point further from away from the inflatable patient transfer mattress than in the compressed state. In some embodiments, in a use configuration, the handle(s) may be securely attached to the inflatable patient transfer mattress at a connection point with at least a part of the handle being movable relative to the inflatable patient transfer mattress. For example, in some embodiments, the handles are configured as flexible loops. The loops may be removably attachable to the inflatable patient transfer mattress and have a fixed connection point in use with a further part of the loop being movable such that a user can manipulate the loops to get a good grip on the handle for moving the inflatable patient transfer mattress.

The inflatable patient transfer mattress may comprise at least one handle and at least one strap. Each or at least one of the at least one handle and at least one strap may be removably attachable to a further portion of the inflatable patient transfer mattress. Each or at least one of the at least one handle and at least one strap may be configured such that, in a stowage configuration, the at least one handle or strap is received by a receiving component such as a pocket on the inflatable patient transfer mattress.

In some embodiments, the inflatable patient transfer mattress comprises a skirt extending around a perimeter of the inflatable patient transfer mattress with at least one opening defined therein and the at least one handle and/or at least one strap may at least partially be (e.g. arranged to be/configured to be) received by the at least one skirt opening in the stowage configuration. For example, the at least one handle or strap may be (e.g. arranged to be/configured to be) threaded through the skirt opening in the stowage configuration.

It will be understood that the further portion of the inflatable patient transfer mattress is typically all parts of the inflatable patient transfer mattress other than the strap (e.g. removably attachable strap) and/or handle (e.g. removably attachable handle), where all parts includes any and all of the other features of the inflatable patient transfer mattress described elsewhere herein. In any case, the further portion is at least one part of the inflatable patient transfer mattress other than the strap (e.g. removably attachable strap) and/or handle (e.g. removably attachable handle).

In some embodiments, the inflatable patient transfer mattress further comprises an attachment, e.g. a housing, for receiving a removably attachable air pump. Thus, the removably attachable air pump can be mounted to the inflatable patient transfer mattress, such as in the housing, to exchange air with the inner region of the inflatable patient transfer mattress at which the housing is provided. The housing may be provided at an external part of the inflatable patient transfer mattress, for example an external side wall. The housing may be made of a rigid material such as a plastics material. The housing provides a rigidity to the inflatable patient transfer mattress when in use and protects the removably attachable air pump when attached to the housing. It may be that the housing is arranged to surround a plurality of sides of the removably attachable air pump when the removably attachable air pump is received in the housing. It may be that the housing extends into the inner region. In this way, the removably attachable air pump does not typically extend significantly or at all beyond the side wall of the inflatable patient transfer mattress when attached to the housing.

According to another aspect of the invention, there is provided a multipack comprising a plurality of breathable covers. The multipack may contain any number of breathable covers greater than one. The breathable covers are as described above—i.e. for overlaying an upper air-permeable region of an upper portion of the first part of an inflatable patient transfer mattress, to form an inflatable patient transfer mattress. The breathable covers comprise securing means for securing the breathable cover to the first part of the inflatable patient transfer mattress, the securing means, when securing the breathable cover to the first part, to cause the breathable cover to restrict air flow from within the mattress to outside the mattress through the upper air-permeable region.

According to another aspect of the invention, there is provided a kit of parts comprising the first part of an inflatable mattress and either a breathable cover or a multipack of breathable covers.

The kit of parts may further comprise an air pump configured to generate a supply of air to supply to the air inlet of the first part of the inflatable patient transfer mattress. The air pump may be a removably attachable air pump, as described hereinbefore.

According to another aspect, there is provided an inflatable patient transfer mattress comprising: a lower portion comprising a lower air-permeable region configured to allow for the transfer of air from within the mattress to outside the mattress therethrough; an upper portion; and an air inlet configured to allow for a supply of air to be provided into an inner region of the mattress, between the lower portion and the upper portion, therethrough, wherein in a single region of the lower portion, including no more than 30 percent of any non air permeable region of the lower portion, and functioning to provide at least 70 percent of the air permeability of the lower air permeable region, at at least 70 percent of surface locations within the single region, a location of the lower portion being air permeable is provided within less than five centimetres.

It will be understood that features of any of the above-described aspects can be combined with any of the features described in relation to any other of the above-described aspects unless inherently incompatible therewith.

### DESCRIPTION OF THE DRAWINGS

Example embodiments of the present invention will now be illustrated with reference to the following Figures in which:

FIG. 1 is a cross sectional view of an inflatable patient transfer mattress according to an example of the present disclosure;

FIG. 2 is a cross sectional view of an inflatable patient transfer mattress according to another example of the present disclosure;

FIG. 3 is a cross sectional view of an inflatable patient transfer mattress according to another example of the present disclosure;

FIGS. 4A and 4B are, respectively, an exploded perspective view of deconstructed parts of a portion of an inflatable patient transfer mattress, and a magnified view of an individual pod of an inflatable patient transfer mattress, according to an example of the present disclosure;

FIGS. 5A and 5B are, respectively, a plan view of an inflatable patient transfer mattress without a patient thereon, and a plan view of the mattress with a patient lying thereon, according to an example of the present disclosure;

FIG. 6 is a perspective view of an inflatable patient transfer mattress according to an example of the present disclosure;

FIG. 7 is a perspective view of an inflatable patient transfer mattress according to an example of the present disclosure; and

FIG. 8 is a plan view of a lower portion of an inflatable patient transfer mattress according to an example of the present disclosure.

### DETAILED DESCRIPTION OF AN EXAMPLE EMBODIMENT

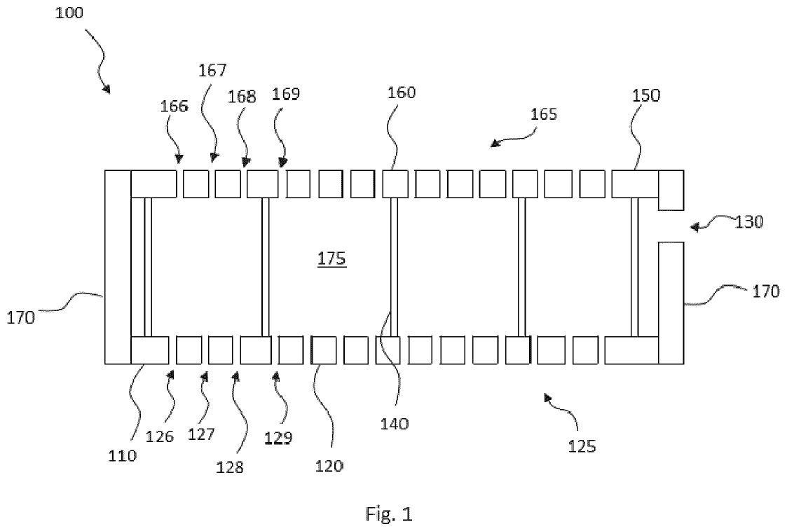

In accordance with an embodiment of the invention, as shown by FIG. 1, there is provided an inflatable patient transfer mattress 100. FIG. 1 shows a cross-sectional view of the inflatable patient transfer mattress 100. The inflatable patient transfer mattress 100 comprises an upper portion 150 separated from a lower portion 110 by side walls 170 (only two side walls are shown however it is to be understood that this inflatable patient transfer mattress 100 comprises four side walls, to define a substantially cuboidal shape). In one of the side walls 170, there is provided an air inlet 130 configured to receive an external air supply to inflate the mattress. The lower portion 110 comprises a lower air-permeable region 120 which allows for the transfer of air therethrough via a plurality of openings 125 distributed throughout the lower air-permeable region 120. The plurality of openings comprises multiple openings, though only openings 126, 127, 128 and 129 are labelled. The upper portion 150 also comprises an upper air-permeable region 160 which allows for the transfer of air therethrough via a plurality of openings 165 distributed throughout the upper air-permeable region 160. The plurality of openings 165 comprises multiple openings, though only openings 166, 167, 168 and 169 are labelled. The upper portion 150 and the lower portion 110 are connected by baffles 140. The baffles 140 extend throughout an inner region 175 of the mattress defined by the enclosed region formed by the upper portion 150, lower portion 110 and side walls 170, and prevent ballooning of the inflatable patient transfer mattress 100 by preventing the upper portion 150 from separating from the lower portion 110 by greater than the vertical length of the baffles 140 in the region of each of the baffles 140. The baffles 140 in this example do not fully extend laterally across a width of the inner region 175 (the direction into the plane of FIG. 1). As such, there are gaps between the ends of baffles 140 and side walls of the mattress 100, which allow different areas of the inner region 175 between adjacent baffles 140 to remain in fluid communication via the gaps between the ends of the baffles 140.

The upper portion 150, lower portion 110 and side walls 170 are made out of a nylon and polyester blend coated with polyurethane. The upper air-permeable region 160 is formed from a PTFE film which is breathable, having the plurality of openings 165 defined therein. Accordingly, the upper air-permeable region 160 comprises an integrally formed breathable portion.

As described further hereinbefore, the plurality of openings 125, 165 of the lower air-permeable region 120 and the upper air-permeable region 160, respectively, are sized and numbered such that the inflatable patient transfer mattress 100, when supplied with a typical air supply through the air inlet 130, will remain inflated even with a patient lying on the upper air-permeable region 160 thereof.

In one example of operation of the inflatable patient transfer mattress 100, the inflatable patient transfer mattress 100 is initially provided in a partially or completed deflated configuration. Next, a patient lies on the upper air-permeable region 160 of the inflatable patient transfer mattress 100. Air is then supplied into the inner region 175 of the inflatable patient transfer mattress 100 through the air inlet 130 from an external air supply (not shown in FIG. 1) and the inner region 175 fills with air. The airflow is provided at a rate which maintains a pressure of approximately 1.5 psi (10.3 Kpa) in the inner region 175 when a patient of average weight lies thereon. It is understood that the average person weighs between 50-100 kg.

Air is continuously supplied through the inlet 130 to the inflatable patient transfer mattress 100. The patient lying thereon naturally exerts a downward force to the inflatable patient transfer mattress 100 and this action ensures that air is expelled from the inner region 175 and out through the plurality of openings 125 in the lower air-permeable region 120 as well as through the plurality of openings 165 in the upper air-permeable region 160. The rate of air provided to the inflatable patient transfer mattress 100 through the air inlet 130 is sufficient to cause the inflatable patient transfer mattress 100 to inflate such that the patient lying on the upper air-permeable region 160 is raised away from the lower air-permeable region 120 until further inflation of the inflatable patient transfer mattress 100 is restricted by the plurality of baffles 140.

Air flow through the plurality of openings 125 in the lower air-permeable region 120 provides a cushion of air which reduces the friction between the lower air-permeable region 120 and a surface with which the lower air-permeable region 120 is in contact. The cushion of air formed between the lower air-permeable region 120 and the surface with which it is in contact allows for the inflatable patient transfer mattress 100 to more easily move over the surface owing to reduced friction and therefore aids in lateral transfer of the patient on the inflatable patient transfer mattress 100 or repositioning of the patient on the inflatable patient transfer mattress on a bed.

The air flow through the plurality of openings 165 of the upper air-permeable region 160 reaches the patient, to thereby provide environmental control. The upper air-permeable region 160 provides comfort to the patient through both the provision of air therethrough, in addition to the breathability which it offers by comprising the integrally formed breathable portion made of PTFE. This material also allows for the wicking of moisture vapour from a patient.

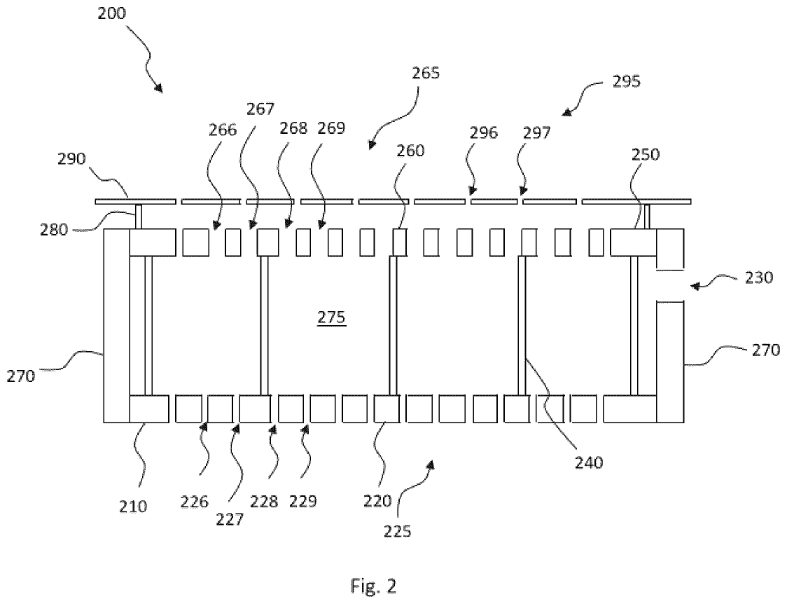

In FIG. 2, another inflatable patient transfer mattress 200 is shown, which is substantially similar to the inflatable patient transfer mattress 100 shown in FIG. 1, apart from the hereinafter described differences. Like features are illustrated with like reference numbers, with the first digit changing from 1 to 2, to represent FIG. 2 instead of FIG. 1 (e.g. the air inlet 130 of FIG. 1 is the air inlet 230 of FIG. 2). Specifically, the inflatable patient transfer mattress 200 includes an upper portion 250, a lower portion 210, side walls 270, an air inlet 230, a lower air-permeable region 220 defining a plurality of openings 225 including openings 226, 227, 228, 229, an upper air-permeable region 260 defining a plurality of openings 265 including openings 266, 267, 268, 269, baffles 240 and an inner region 275, substantially as described with reference to FIG. 1 hereinbefore.

In the example shown in FIG. 2, the inflatable patient transfer mattress 200 further comprises a breathable portion 290 attached to the upper portion 250 via securing means 280.

As in the example shown in FIG. 1, the upper air-permeable region 260 has a plurality of openings 265 defined therein. In FIG. 2, the plurality of openings 265 take the form of through-holes 266, 267, 268, 269 that provide a passage for air from within the inner region 275 to out of the inner region 275 through the upper permeable region 260. The breathable portion 290 is disposed over the upper air-permeable region 260 and is formed from a PTFE film. The PTFE film of the breathable portion 290 comprises a plurality of openings 295, including a first opening 296 and a second opening 297 (and other openings, not labelled in FIG. 2) which are smaller in extent than each of the plurality of openings 265 in the upper air-permeable region 260. The breathable portion 290 is secured to the upper portion 250 through Velcro® securing means 280 arranged around a perimeter of the upper air-permeable region 260. The connection between the upper portion 250 and the breathable portion 290 by the securing means 280 ensures that the mattress remains inflated when air is supplied through the inlet 230 and a patient lies thereon.

The mattress 200 is used in substantially the same way as the mattress 100 described above, apart from the hereinafter described differences. The combination of the upper air-permeable region 260 and the breathable cover 290 allows for air to transfer from the inner region 275 of the mattress 200 and through both the plurality of openings 265 of the upper air-permeable region 260 and through the plurality of openings 295 in the breathable portion 290. Accordingly, the patient is provided with a comfortable environment through the provision of air to their body, whilst also having the advantage of a removable breathable portion 290 which can be replaced when used and/or soiled. The provision of the plurality of openings 295 in the breathable portion 290 each having a smaller size compared to the plurality of perforations 265 in the upper air-permeable region 260 allows for the air mattress 200 to retain an inflated state when a patient lies thereon. The smaller size of the plurality of openings 295 in the breathable portion 290 also provides added comfort to the patient by providing moisture wicking properties whilst maintaining its waterproof properties.

In the example shown in FIG. 2, the breathable portion 290 is formed from an absorbent material, therefore having absorbent properties, as described elsewhere hereinbefore.

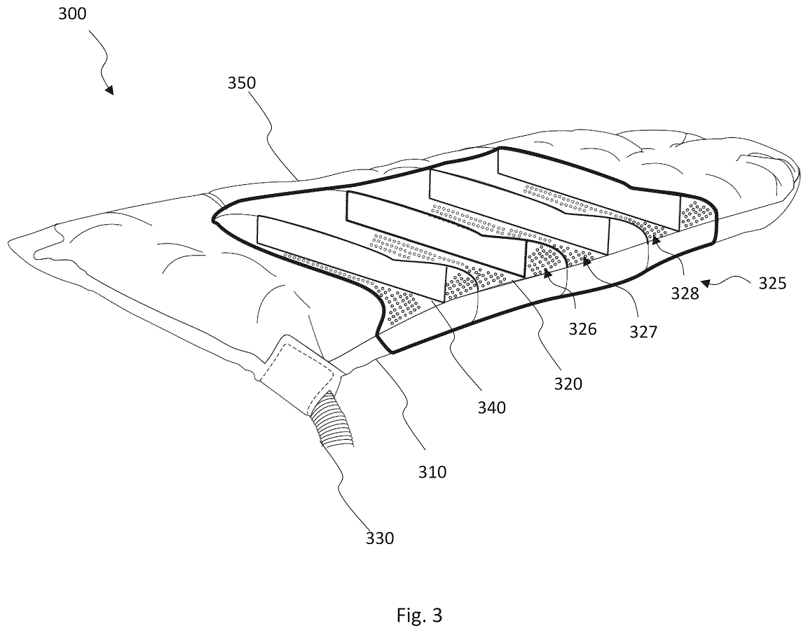

FIG. 3 shows a cross sectional view of an embodiment of the invention showing an inflatable patient transfer mattress 300. The inflatable patient transfer mattress 300 comprises baffles 340 which extend throughout the inner region (not labelled) of the mattress. In this embodiment, the mattress does not comprise side walls and instead, the upper portion 350 is connected to the lower portion 310 at a periphery thereof using high frequency welding. When air enters the inner region of the mattress 300 through inlet 330, the mattress 300 fills with air and inflates. The baffles 340 act to reinforce the structure of the mattress on inflation so as to prevent ballooning. In this embodiment the lower portion 310 comprises a lower air permeable region 320 in which a plurality of perforations 325 are defined. Of the plurality of perforations 325, only perforations 326, 327, 328 are labelled. In FIG. 3, the plurality of perforations 325 take the form of through-holes 326, 327, 328 that provide a passage for air from within the inner region to out of the inner region through the lower air-permeable region 320. The upper portion 350 is formed of a breathable film in which a plurality of openings are defined (not shown) and thus the upper portion 350 also defines the upper air-permeable region.

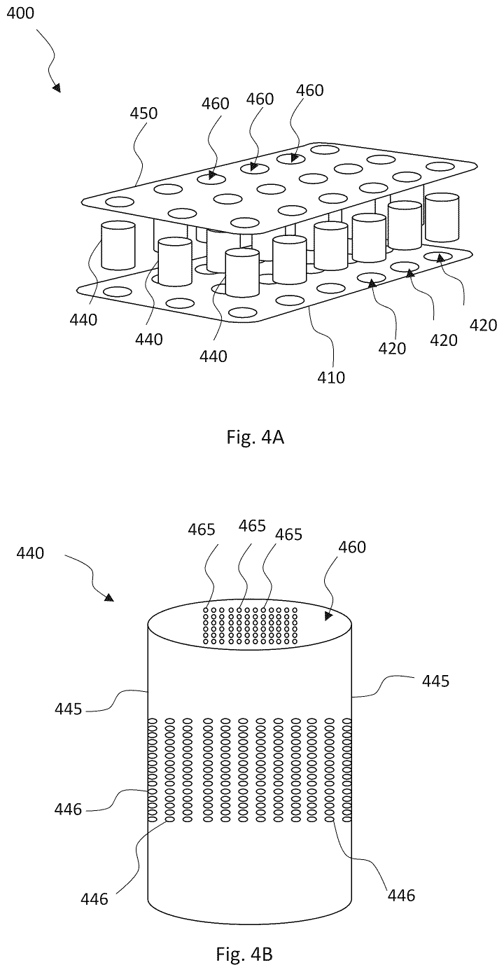

As described above, in some embodiments, the connecting means to prevent ballooning of the inflatable patient transfer mattress 100, 200, 300 are baffles 140, 240, 340. In other embodiments the connecting means can be pods. FIG. 4A shows an exploded schematic view of an inflatable patient transfer mattress 400 comprising pods 440 as connecting means which connect an upper portion 450 to a lower portion 410 of the inflatable patient transfer mattress 400. Specifically, FIG. 4A shows the upper portion 450, the pods 440 and the lower portion 410 as deconstructed layers to aid in visualization of the parts of the inflatable patient transfer mattress 400. Accordingly, it will be understood that the mattress 400 is, in its simplest form, similar to the mattresses shown in FIGS. 1 and 2. In other words, the upper portion 450 and lower portion 410 are connected by the pods 440. The mattress also comprises side walls and an inlet which allows for an external air supply to provide air into an inner region of the mattress, though these parts are not shown in FIG. 4 to aid visualisation of the pods 440. As can be seen from FIG. 4A, the pods extend vertically between the upper portion 450 and the lower portion 410.

FIG. 4B shows the magnified structure of a pod 440 for the inflatable patient transfer mattress 400 shown in FIG. 4A. The pod 440 is arranged to extend through an inner region of the inflatable patient transfer mattress 400 (not shown). In this embodiment, an upper surface 460 of the pod 440 functions as part of the upper air-permeable region of the inflatable patient transfer mattress 400. In this way, the upper air-permeable region includes the entire upper surface 460 of pod 440 at the upper portion 450 of mattress 400. The pod 440 comprises a plurality of openings 465 on the upper surface 460 of the pod 440 providing at least some of the plurality of openings 165, 265 described hereinbefore. The pod 440 also comprises a plurality of openings 446 in a side wall 445 of the pod 440. In this embodiment, the upper air-permeable region 460 is only located on the upper surfaces of each of the plurality of pods 440 in the inflatable patient transfer mattress 400. Accordingly, in operation, when air is provided into the mattress inner region through an inlet (not shown in FIG. 4A), the air passes through openings 446 in the side wall 445 of pod 440 before passing out of the inflatable patient transfer mattress 400 through openings 465 located on the upper surface of the pod 460. Accordingly, the pods 440 provide a route for air to escape from within the inflatable patient transfer mattress 400 to outside the inflatable patient transfer mattress 400 through the pod 440 structure. Although not shown, it will be understood that in many of the examples described herein, the pod 440 may further define a plurality of openings on a lower surface thereof to allow air to escape from within the inflatable patient transfer mattress 400 via the lower air-permeable region.

In some embodiments, the upper air-permeable region may only form a part of a surface of a pod. The air-permeable region may be provided on both a part of the upper surface of the pod in addition to another region of the upper portion different to the upper surface of a pod. Alternatively, the upper air-permeable region may not include any part of the upper surface of a pod. When the air-permeable region is only formed on the upper surface of the pod, the pod must comprise openings in a side wall of the pod extending through an inner region of the mattress to allow air to enter the pod and escape out of the mattress. If the air-permeable region is provided on any region of the upper portion which is not the pod, it will be understood that there is not always a requirement for the pod to comprises holes in a sidewall thereof.

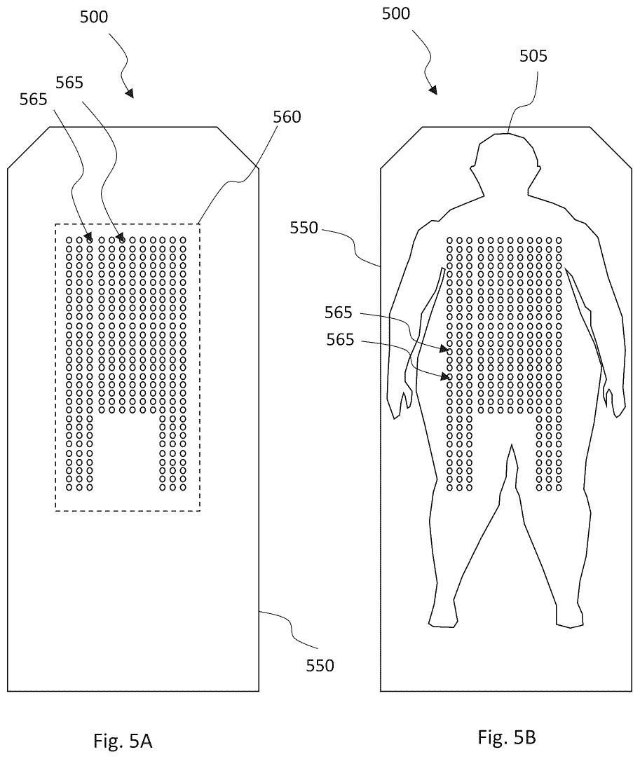

FIG. 5A shows an inflatable patient transfer mattress 500 comprising an upper portion 550 and an upper air-permeable region 560 comprising a plurality of openings 565 therein. FIG. 5B shows the inflatable patient transfer mattress 500 with a patient 505 lying thereon. The air-permeable region 560 is arranged in a central area of the upper portion 550. Accordingly, when a patient 505 lies on the inflatable patient transfer mattress 500, the patient covers a large part of, if not all of, the upper air-permeable region 560. In this way the patient 505 benefits from air provision from the inner region of the inflatable patient transfer mattress 500 through the plurality of openings 565 directly to their body.

It will be understood that the upper air-permeable region may be arranged on any part of the upper portion of an inflatable patient transfer mattress. In some embodiments, the upper air-permeable region may be configured in strips which run an entire length of the upper portion of the mattress. In some embodiments, the upper air-permeable region may be configured to cover a certain area of the upper portion of the mattress, for example from 30 to 80% of the upper portion area.

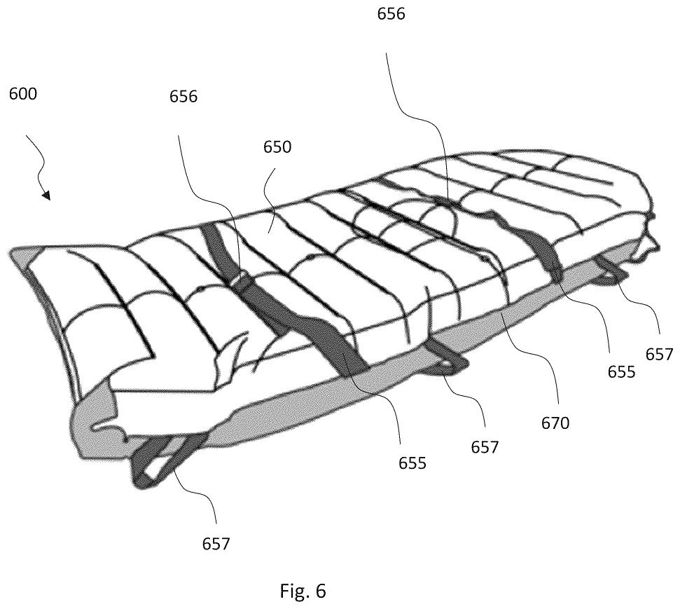

FIG. 6 shows an inflatable patient transfer mattress 600 comprising straps 655, handles 657 and upper portion 650, other features such as the air inlet are not shown in this figure. The straps 655 and handles 657 are removably attachable to the inflatable patient transfer mattress and are attached to the side walls 670 of the inflatable patient transfer mattress 600 by attachment means such as hook and loop type fasteners, zips, or any other suitable attachment means. There are two sets of removably attachable straps 655 which are attached to the inflatable patient transfer mattress 600. Each set of straps 655 comprises an adjustable buckle 656 that can be loosened or tightened to secure the patient comfortably to the inflatable patient transfer mattress. The straps 655 can be attached to the inflatable patient transfer mattress 600 prior to inflation or following inflation. After the patient has used the inflatable patient transfer mattress 600 and it is ready to be deflated, the straps 655 can be removed and therefore they do not trail on the ground. As shown in FIG. 6, the straps 655 are typically provided in the form of two-part straps 655 having a first portion and a second portion, arranged to connect to each other via the adjustable buckle 656 to secure the patient. The adjustable buckle 656 is a two-part connection member, with a first part of the adjustable buckle 656 connected to the first portion of the two-part strap 655 and a second part of the adjustable buckle 656 connected to the second portion of the two-part strap 655. There are three pairs of handles 657 on two opposing side walls of the inflatable patient transfer mattress. The handles 657 are arranged as loops of fabric material that allow for movement of the loop about connection points (not shown) arranged on each side wall. In use, when lifting or moving a patient, a user or multiple users can pull on the handle(s) to move the mattress 600 across a surface with or without a patient lying thereon. When the inflatable patient transfer mattress 600 has been moved or no longer needs to be moved, the handles 657 can be removed at the connection point and placed either externally, away from the inflatable patient transfer mattress, or on a receiving compartment located on the inflatable patient transfer mattress (not shown).

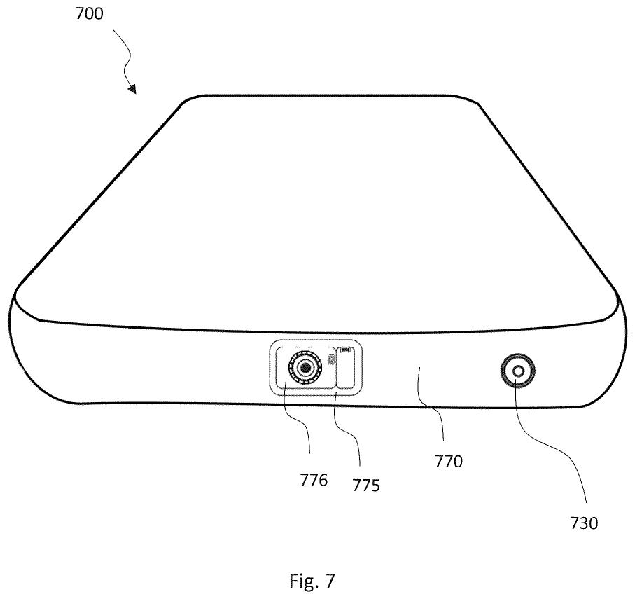

FIG. 7 shows an inflatable patient transfer mattress 700 comprising an inlet 730 in one of the side walls 770. Also provided in the side wall 770 is a housing 775 which extends into the inner region (not shown) of the inflatable patient transfer mattress 700. The housing 775 is arranged as a sealed compartment within the inner region of the inflatable patient transfer mattress 700 that can receive a removably attachable air pump 776 therein. In this arrangement, the removably attachable air pump 776 can be inserted in the housing 775, and the air pump 776 can inflate the inner region of the inflatable patient transfer mattress 700 when the air inlet 730 is opened.

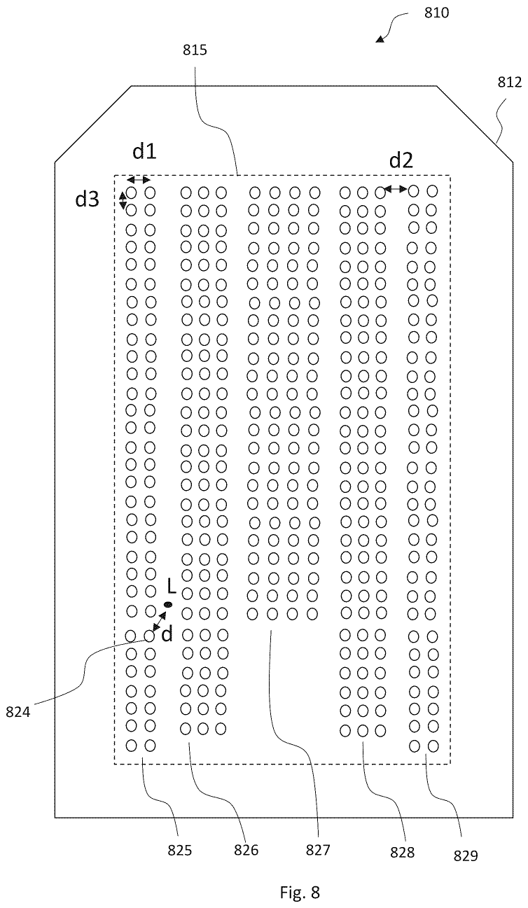

FIG. 8 shows a lower portion 810 of an inflatable patient transfer mattress with and outer perimeter 812 and a single region 815 defined therein. The single region 815 comprises five groups of openings 825, 826, 827, 828, 829 arranged into columns and rows in each group. The distance, d1, represents the distance between the adjacent columns in group 825. The distance d3 represents the distance between the openings between adjacent rows in the group 825. The distance d2 represents the distance between adjacent groups 828 and 829. The distance d2 is greater than distances d1 and d3. The single region provides greater than 70% of the air permeability of the lower portion through the openings in the single region. At at least 70% of the surface locations within the single region 815, there is provided an opening within less than 5 cm. One of the surface locations, L, is shown in the single region 815 at a distance, d, away from an opening 824. The distance, d, is less than 5 centimetres. There is a lower distribution of openings in the bottom end of the single region. Above this bottom region, in the upper portion of the patient transfer mattress (not shown), less heavy parts of a patient such as the feet or lower legs will lie thereon. Moreover, the groups such as 825 and 829 nearest the outer perimeter 812 comprise fewer columns of openings than the groups such as 826, 827, 828 nearest a central part of the single region. Similarly, the less heavy parts of a patient such as the arms will be located above this region in the inflatable patient transfer mattress. Accordingly, the arrangement of the lower portion shown in FIG. 8 shows there to be a largely uniform distribution of openings within the single region of the lower portion. In this way, when a patient lies on the inflatable patient transfer mattress and the heaviest part of their body is directly above the lower portion which comprises the uniform distribution of openings, an enhanced expulsion of air from the inflatable patient transfer mattress contributes to an improved cushioning of the inflatable patient transfer mattress and eases lifting and sliding across a surface.

In summary, there is provided an inflatable patient transfer mattress (100, 200, 300, 400, 500) comprising: a lower portion (110, 210, 310, 410) comprising a lower air-permeable region (120, 220, 320, 420) configured to allow for the transfer of air from within the mattress (100, 200, 300, 400, 500) to outside the mattress (100, 200, 300, 400, 500) therethrough; an upper portion (150, 250, 350, 450, 550) comprising an upper air-permeable region (160, 260,, 460, 560) configured to allow for the transfer of air from within the mattress (100, 200, 300, 400, 500) to outside the mattress (100, 200, 300, 400, 500) therethrough; and an air inlet (130, 230, 330) configured to allow for a supply of air to be provided into an inner region (175, 275) of the mattress (100, 200, 300, 400, 500), between the lower portion (110, 210, 310, 410) and the upper portion (150, 250, 350, 450, 550), therethrough.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An inflatable patient transfer mattress comprising:
a lower portion comprising a lower air-permeable region configured to allow for the transfer of air from within the mattress to outside the mattress therethrough;
an upper portion comprising an upper air-permeable region configured to allow for the transfer of air from within the mattress to outside the mattress therethrough; and
an air inlet configured to allow for a supply of air to be provided into an inner region of the mattress, between the lower portion and the upper portion, therethrough.

2. The inflatable patient transfer mattress according to claim 1, wherein the upper air-permeable region comprises a breathable portion.

3. The inflatable patient transfer mattress according to claim 1, wherein the inflatable patient transfer mattress further comprises a breathable portion secured to the upper portion and disposed over the upper air-permeable region such that, when inflated, a rate of air flow from within the mattress, through the upper air-permeable region and out through the breathable portion is sufficiently low that the mattress remains inflated.

4. A first part of an inflatable patient transfer mattress comprising:
a lower portion comprising a lower air-permeable region configured to allow for the transfer of air from within the first part to outside the first part therethrough; and an upper portion comprising an upper air-permeable region configured to allow for the transfer of air from within the first part to outside the first part therethrough; and
an air inlet configured to allow for a supply of air to be provided into an inner region of the first part, between the lower portion and the upper portion, therethrough, wherein the first part of the inflatable patient transfer mattress is configured to form the inflatable patient transfer mattress when a breathable cover is secured to the upper portion and disposed over the upper air-permeable region, and wherein the upper air-permeable region is configured such that, in the absence of the breathable cover disposed over the upper air-permeable region and when an air supply is provided into the inner region of the first part, the first part will deflate with a patient lying thereon.

5. The inflatable patient transfer mattress according to claim 1, wherein the upper air-permeable region and/or the lower air permeable region comprises a plurality of openings.

6. The inflatable patient transfer mattress according to claim 5, wherein each of the openings in the plurality of openings is sized to prevent the passage of liquid therethrough.

7. The inflatable patient transfer mattress according to claim 5, wherein a surface area of each of the openings in the plurality of openings is such that a liquid is prevented from passing therethrough.

8. The inflatable patient transfer mattress according to claim 1, wherein in a single region of the lower portion, including no more than 30 percent of any non air permeable region of the lower portion, and functioning to provide at least 70 percent of the air permeability of the lower air permeable region, at at least 70 percent of surface locations within the single region, a location of the lower portion being air permeable is provided within less than five centimetres.

9. The inflatable patient transfer mattress according to claim 1, further comprising at least one connecting element extending between the upper portion and the lower portion of the mattress through the inner region.

10. The inflatable patient transfer mattress according to claim 9, wherein the at least one connecting element defines at least part of a plurality of pods.

11. The inflatable patient transfer mattress according to claim 10, wherein the plurality of pods extend along a height of the inner region from the lower portion to the upper portion of the mattress.

12. The inflatable patient transfer mattress according to claim 11, wherein at least a part of the upper air-permeable region forms part of an upper surface of the pod at the upper portion of the mattress.

13. The inflatable patient transfer mattress according to any of claim 8, wherein the at least one connecting element defines at least part of a plurality of baffles.

14. The inflatable patient transfer mattress according to claim 13, wherein each of the plurality of baffles extends laterally across at least 50% of a width of the mattress through the inner region.

15. The inflatable patient transfer mattress according to claim 1, wherein the upper portion either comprises an absorbent portion or is provided with an absorbent layer disposed thereon.

16. A breathable cover for overlaying an upper air-permeable region of an upper portion of the first part according to claim 4, to form an inflatable patient transfer mattress, wherein the breathable cover comprises securing means for securing the breathable cover to the first part of the inflatable patient transfer mattress, the securing means, when securing the breathable cover to the first part, to cause the breathable cover to restrict air flow from within the mattress to outside the mattress through the upper air-permeable region.

17. The breathable cover according to claim 16, wherein an outer perimeter of the securing means encloses an area of the breathable cover of at least 0.1 m².

18. (canceled)

19. The inflatable patient transfer mattress according to claim 1, further comprising at least one strap for securing a patient to the inflatable patient transfer mattress, wherein the at least one strap is removably attachable to a further portion of the inflatable patient transfer mattress and/or at least partially configured to be received by a receiving component on a further portion of the inflatable patient transfer mattress.

20. The inflatable patient transfer mattress according to claim 1, further comprising at least one handle, wherein the at least one handle is removably attachable to a further portion of the inflatable patient transfer mattress and/or at least partially configured to be received by a receiving component on a further portion of the inflatable patient transfer mattress.

21. The inflatable patient transfer mattress according to claim 1, further comprising a housing for receiving a removably attachable air pump.

22. (canceled)

23. (canceled)

24. (canceled)

25. (canceled)
